(19) United States
(12) Patent Application Publication
(10) Pub. No.: US 2021/0158071 A1
(43) Pub. Date: May 27, 2021

(54) MATCH DETERMINATION DEVICE, MATCH DETERMINATION METHOD, STORAGE MEDIUM

(71) Applicant: NEC Corporation, Minato-ku, Tokyo (JP)

(72) Inventors: Satoshi YOSHIDA, Tokyo (JP); Shoji NISHIMURA, Tokyo (JP); Jianquan LIU, Tokyo (JP)

(73) Assignee: NEC Corporation, Minato-ku, Tokyo (JP)

(21) Appl. No.: 16/960,225

(22) PCT Filed: Jan. 8, 2019
(86) PCT No.: PCT/JP2019/000159

§ 371 Date: Jul. 6, 2020

(30) Foreign Application Priority Data
Jan. 10, 2018 (JP) 2018-002207

(51) Int. Cl. G06K 9/46; G06K 9/00

(52) U.S. Cl. CPC G06K 9/4609; G06K 9/00275; G06K 9/00758; G06K 9/00744

(57) ABSTRACT

Provided is a match determination device that efficiently specifies the same analysis target from a plurality of pieces of sensing information. The present invention specifies a selected feature quantity that has been selected from one or more feature quantities for analysis targets that are included in analysis groups and, on the basis of a combination of selected feature quantities from different analysis groups, evaluates whether there are matching analysis targets between a plurality of analysis groups. When the evaluation indicates that there are matching analysis targets between analysis groups, the present invention specifies that analysis targets in the different analysis groups are the same target.

### TECHNICAL FIELD

The present invention relates to a match determination device, a match determination method, and a storage medium.

### BACKGROUND ART

There is a technique for tracking specific information, for example, a moving object from sensing information such as video. For example, NPL 1 discloses a video tracking technique. Further, NPL 2 discloses a technique for specifying the same person on a plurality of pieces of video data. Further, a technique related to the present invention is disclosed in PTL 1.

### CITATION LIST

### Patent Literature

[PTL 1] Japanese Unexamined Patent Application Publication No. 2016-001447

### Non Patent Literature

[NPL 1] “Object Tracking: A Survey” [online], [retrieved on Dec. 26, 2017], Internet <URL: http://citeseerx.ist.psu.edu/viewdoc/download?doi=10.1.1.112.8588&rep=rep1&t ype=pdf>

[NPL 2] “Person Re-identification: Past, Present and Future” [online], [retrieved on Dec. 26, 2017], Internet <URL: https://arxiv.org/abs/1610.02984>

### SUMMARY OF INVENTION

### Technical Problem

In the tracking technique as described above, the same analysis target needs to be efficiently specified from a plurality of pieces of sensing information.

Thus, an object of the present invention is to provide a match determination device, a match determination method, and a program, being able to efficiently specify the same analysis target from a plurality of pieces of sensing information.

### Solution to Problem

According to a first aspect of the invention, a match determination device includes an evaluation unit that specifies a selected feature quantity being selected from one or a plurality of feature quantities for an analysis target included in an analysis group, and evaluates, based on a combination of the selected feature quantities between different analysis groups, whether the analysis targets between a plurality of the analysis groups match, and a determination unit that specifies the analysis target in each of the different analysis groups as a same target when the evaluation indicates that the analysis targets between the analysis groups match.

According to a second aspect of the invention, a match determination method includes specifying a selected feature quantity being selected from one or a plurality of feature quantities for an analysis target included in an analysis group, evaluating, based on a combination of the selected feature quantities between different analysis groups, whether the analysis targets between a plurality of the analysis groups match, and specifying the analysis target in each of the different analysis groups as a same target when the evaluation indicates that the analysis targets between the analysis groups match.

According to a third aspect of the invention, a program causing a computer of a match determination device to function as an evaluation means for specifying a selected feature quantity being selected from one or a plurality of feature quantities for an analysis target included in an analysis group, and evaluating, based on a combination of the selected feature quantities between different analysis groups, whether the analysis targets between a plurality of the analysis groups match, and a determination means for specifying the analysis target in each of the different analysis groups as a same target when the evaluation indicates that the analysis targets between the analysis groups match.

### Advantageous Effects of Invention

According to the present invention, the same analysis target is able to be efficiently specified from a plurality of pieces of sensing information.

### BRIEF DESCRIPTION OF DRAWINGS

FIG. 1 is a diagram illustrating a configuration of an analysis system according to one example embodiment of the present invention.

FIG. 2 is a hardware configuration diagram of a match determination device according to one example embodiment of the present invention.

FIG. 3 is a first diagram illustrating a functional block of the match determination device according to one example embodiment of the present invention.

FIG. 4 is a functional block diagram of a combination unit according to one example embodiment of the present invention.

FIG. 5 is a first diagram illustrating an outline of match determination processing according to one example embodiment of the present invention.

FIG. 6 is a first diagram illustrating a processing flow of the match determination processing according to one example embodiment of the present invention.

FIG. 7 is a second diagram illustrating an outline of match determination processing according to one example embodiment of the present invention.

FIG. 8 is a second diagram illustrating a processing flow of the match determination processing according to one example embodiment of the present invention.

FIG. 9 is a third diagram illustrating an outline of match determination processing according to one example embodiment of the present invention.

FIG. 10 is a third diagram illustrating a processing flow of the match determination processing according to one example embodiment of the present invention.

FIG. 11 is a fourth diagram illustrating an outline of match determination processing according to one example embodiment of the present invention.

FIG. 12 is a fourth diagram illustrating a processing flow of the match determination processing according to one example embodiment of the present invention.

FIG. 13 is a second diagram illustrating a functional block of the match determination device according to one example embodiment of the present invention.

FIG. 14 is a third diagram illustrating a functional block of the match determination device according to one example embodiment of the present invention.

FIG. 15 is a fourth diagram illustrating a functional block of the match determination device according to one example embodiment of the present invention.

FIG. 16A is a first diagram illustrating an outline of a feature quantity used for calculating a degree of similarity by a match determination device 1 according to one example embodiment of the present invention.

FIG. 16B is a first diagram illustrating an outline of a feature quantity used for calculating a degree of similarity by the match determination device 1 according to one example embodiment of the present invention.

FIG. 17 is a fifth diagram illustrating a functional block of the match determination device according to one example embodiment of the present invention.

FIG. 18A is a first diagram illustrating an outline of feature quantity information and meta-information used for calculating a degree of similarity by the match determination device according to one example embodiment of the present invention.

FIG. 18B is a first diagram illustrating an outline of feature quantity information and meta-information used for calculating a degree of similarity by the match determination device according to one example embodiment of the present invention.

FIG. 19 is a sixth diagram illustrating a functional block of the match determination device according to one example embodiment of the present invention.

FIG. 20 is a seventh diagram illustrating a functional block of the match determination device according to one example embodiment of the present invention.

FIG. 21A is a second diagram illustrating an outline of feature quantity information and meta-information used for calculating a degree of similarity by the match determination device according to one example embodiment of the present invention.

FIG. 21B is a second diagram illustrating an outline of feature quantity information and meta-information used for calculating a degree of similarity by the match determination device according to one example embodiment of the present invention.

FIG. 22 is an eighth diagram illustrating a functional block of the match determination device according to one example embodiment of the present invention.

FIG. 23 is a ninth diagram illustrating a functional block of the match determination device according to one example embodiment of the present invention.

FIG. 24 is a diagram illustrating a minimum configuration of the match determination device according to one example embodiment of the present invention.

### EXAMPLE EMBODIMENT

Hereinafter, an analysis system according to one example embodiments of the present invention will be described with reference to drawings.

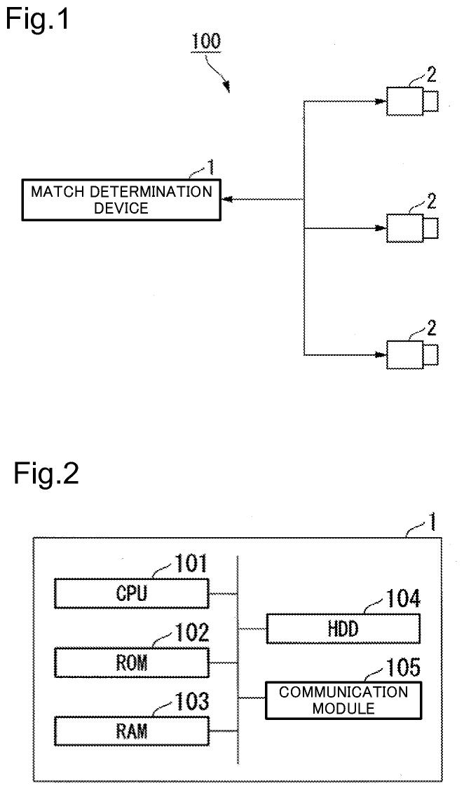

FIG. 1 is a diagram illustrating a configuration of the analysis system according to one example embodiment of the present invention.

As illustrated in FIG. 1, an analysis system 100 includes a match determination device 1 and a plurality of cameras 2. The cameras 2 are disposed at an interval on a road on which a person moves. In the present example embodiment, it is assumed that capturing ranges of the respective cameras 2 do not overlap each other, but the capturing ranges may overlap each other. As one example, the cameras 2 may be installed at a distance of 100 m or more from each other. Each of the cameras 2 communicates with and is connected to the match determination device 1 via a communication network. Each of the cameras 2 transmits video data generated by capturing to the match determination device 1. The match determination device 1 receives the video data.

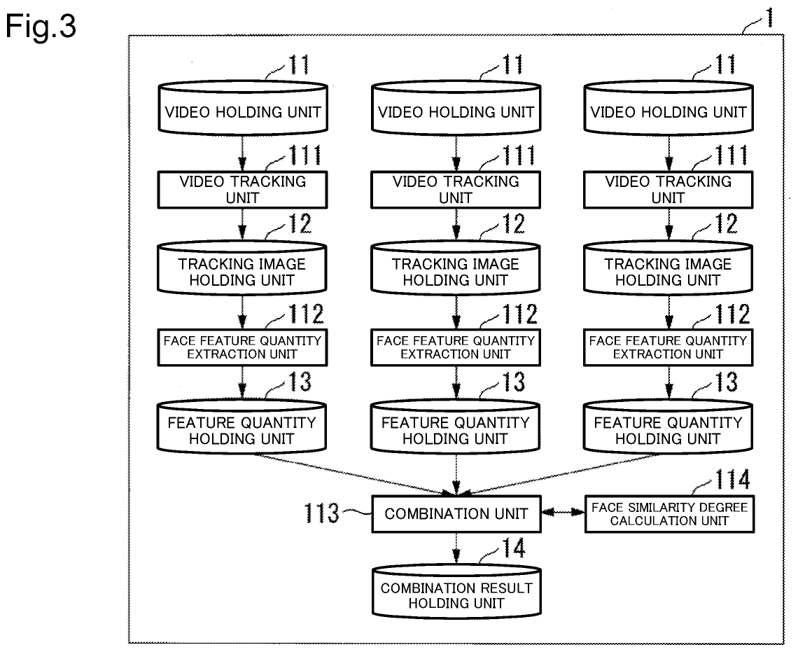

FIG. 2 is a hardware configuration diagram of the match determination device.

As illustrated in FIG. 2, the match determination device 1 is a computer that includes each piece of hardware such as a central processing unit (CPU) 101, a read only memory (ROM) 102, a random access memory (RAM) 103, a hard disk drive (HDD) 104, and a communication module 105.

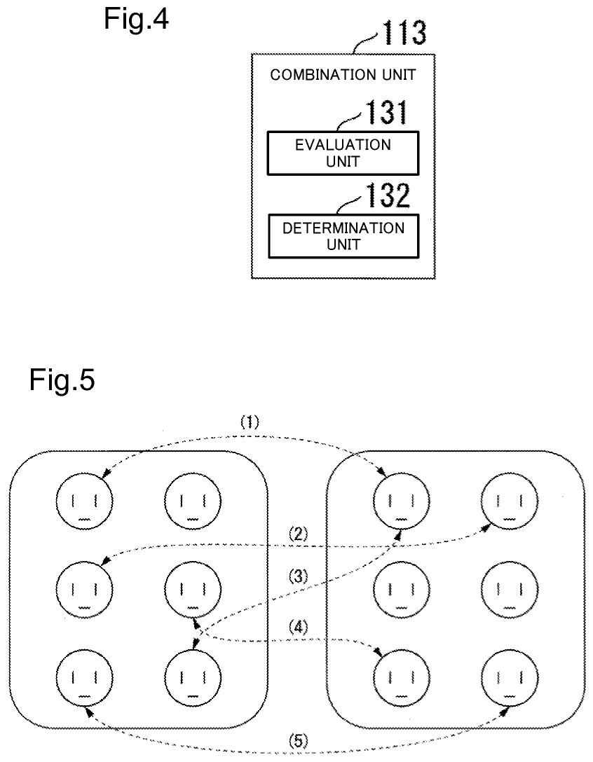

FIG. 3 is a first diagram illustrating a functional block of the match determination device. The match determination device 1 is activated by turning on the power, and executes a match determination program being previously stored. In this way, the match determination device 1 includes functions of a video tracking unit 111, a face feature quantity extraction unit 112, a combination unit 113, and a face similarity degree calculation unit 114. The match determination device 1 constitutes, inside the HDD 104, a storage region equivalent to a video holding unit 11, a tracking image holding unit 12, a feature quantity holding unit 13, and a combination result holding unit 14. Note that the match determination device 1 includes the video tracking unit 111, the face feature quantity extraction unit 112, the video holding unit 11, the tracking image holding unit 12, and the feature quantity holding unit 13 for the number of cameras to be communicated and connected.

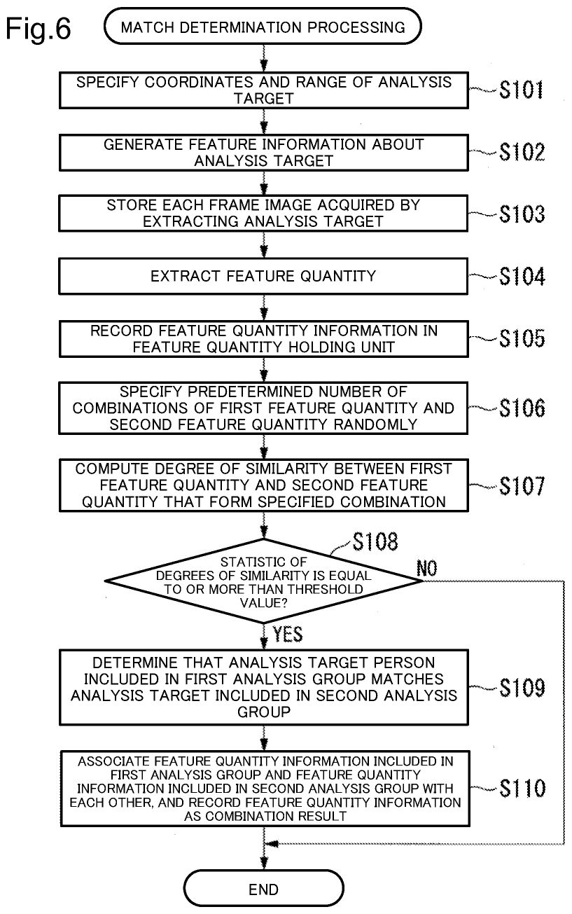

FIG. 4 is a functional block diagram of the combination unit. The combination unit 113 includes functions of an evaluation unit 131 and a determination unit 132. The evaluation unit 131 specifies a selected feature quantity being selected from one or a plurality of feature quantities for an analysis target included in an analysis group. The evaluation unit 131 evaluates, based on a combination of selected feature quantities between different analysis groups, whether the analysis targets between the plurality of analysis groups match. When the evaluation indicates that the analysis targets between the analysis groups match, the determination unit 132 specifies that the analysis targets in the respective different analysis groups are the same target.

### (First Match Determination Processing)

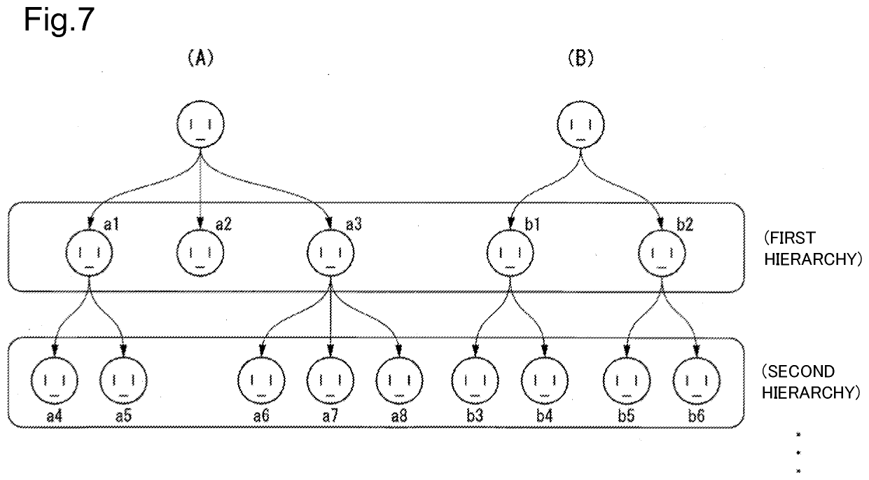

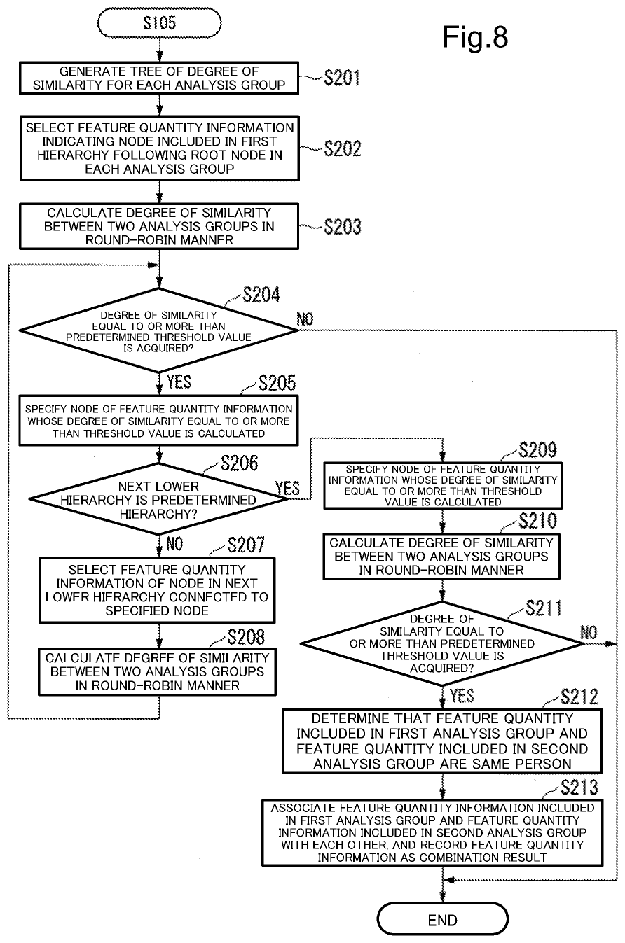

FIG. 5 is a first diagram illustrating an outline of match determination processing. FIG. 6 is a first diagram illustrating a processing flow of the match determination processing. Next, the processing flow of the match determination device will be described.

In each of the video holding units 11, video data transmitted from the camera 2 communicated and connected in association with each of the video holding units 11 are accumulated. The video tracking unit 111 reads the accumulated video data of the video holding unit 11. The video tracking unit 111 specifies coordinates and a range of a specific person as an analysis target captured in each frame image included in the video data (step S101). The video tracking unit 111 generates feature information about the specific person captured in the frame image (step S102). The video tracking unit 111 stores, in the tracking image holding unit 12, each frame image acquired by extracting the person (step S103). A known technique may be used as a technique of video tracking for extracting and tracking a person. The face feature quantity extraction unit 112 reads the frame image stored in the tracking image holding unit 12. The face feature quantity extraction unit 112 specifies a range of a face of the person captured in the frame image, and extracts a face feature quantity, based on pixel information included in the range of the face (step S104). A known technique may be used as an extraction technique of a face feature quantity. The face feature quantity extraction unit 112 records, in the feature quantity holding unit 13, an ID of the frame image, coordinates indicating the range of the face in the image, and feature quantity information associated with the face feature quantity (step S105). The face feature quantity extraction unit 112 performs similar processing on all frame images stored in the tracking image holding unit 12. The match determination device 1 performs the processing mentioned above on each piece of video data transmitted from each of the cameras 2.

As one example, the combination unit 113 acquires, from each of the feature quantity holding units 13, feature quantity information generated based on video data transmitted from three cameras 2. It is assumed that the three cameras 2 are each referred to as a first camera 2, a second camera 2, and a third camera 2. It is also assumed that feature quantity information generated based on video data of the first camera 2 is referred to as feature quantity information in a first analysis group. It is also assumed that feature quantity information generated based on video data of the second camera 2 is referred to as feature quantity information in a second analysis group. It is also assumed that feature quantity information generated based on video data of the third camera 2 is referred to as feature quantity information in a third analysis group.

In the combination unit 113, first, the evaluation unit 131 randomly specifies, among round-robin combinations of a first feature quantity included in the feature quantity information included in the first analysis group and a second feature quantity included in the feature quantity information included in the second analysis group, a predetermined number of combinations of the first feature quantity and the second feature quantity (step S106). Each of the feature quantities included in the specified combination is a selected feature quantity. In FIG. 5, specification of five combinations indicated by (1) to (5) is indicated by a broken line. The broken line indicates a relationship between the first feature quantity and the second feature quantity that form the specified combination. The face similarity degree calculation unit 114 computes a degree of similarity between the first feature quantity and the second feature quantity that form the specified combination, based on an instruction of the evaluation unit 131 (step S107). A known technique may be used for computing a degree of similarity. The evaluation unit 131 determines whether a statistic (such as an average value) of the degrees of similarity is equal to or more than a predetermined threshold value (step S108). When any degree of similarity among the degrees of similarity is equal to or more than the predetermined threshold value, the evaluation unit 131 determines that a person being an analysis target included in the first analysis group matches a person being an analysis target included in the second analysis group (step S109). The processing of the evaluation unit 131 is one aspect of processing of evaluating, based on a combination of selected feature quantities between different analysis groups, whether analysis targets between the plurality of analysis groups match.

When the determination unit 132 determines that the person being the analysis target included in the first analysis group matches the person being the analysis target included in the second analysis group, the determination unit 132 specifies that feature quantity information about the person being the analysis target included in the first analysis group and feature quantity information about the person being the analysis target included in the second analysis group are feature quantity information about the same person. The determination unit 132 associates the feature quantity information included in the first analysis group and the feature quantity information included in the second analysis group with each other, and records the feature quantity information as a combination result in the combination result holding unit 14 (step S110).

The combination unit 113 may perform similar processing by using the first feature quantity among the pieces of feature quantity information included in the first analysis group and a third feature quantity among the pieces of feature quantity information included in the third analysis group. Furthermore, the combination unit 113 may perform similar processing by using the second feature quantity among the pieces of feature quantity information included in the second analysis group and the third feature quantity among the pieces of feature quantity information included in the third analysis group.

According to the processing of the combination unit described above, a similarity degree determination of a feature quantity is performed between analysis groups including a feature quantity of a specific person tracked by the video tracking unit 111, and thus a matching determination of a person captured in a plurality of pieces of video can be performed with higher accuracy. Further, a degree of similarity is determined by using only a selected feature quantity among feature quantities included in feature quantity information included in an analysis group, and thus processing of a similarity degree determination can be performed at high speed.

### (Second Match Determination Processing)

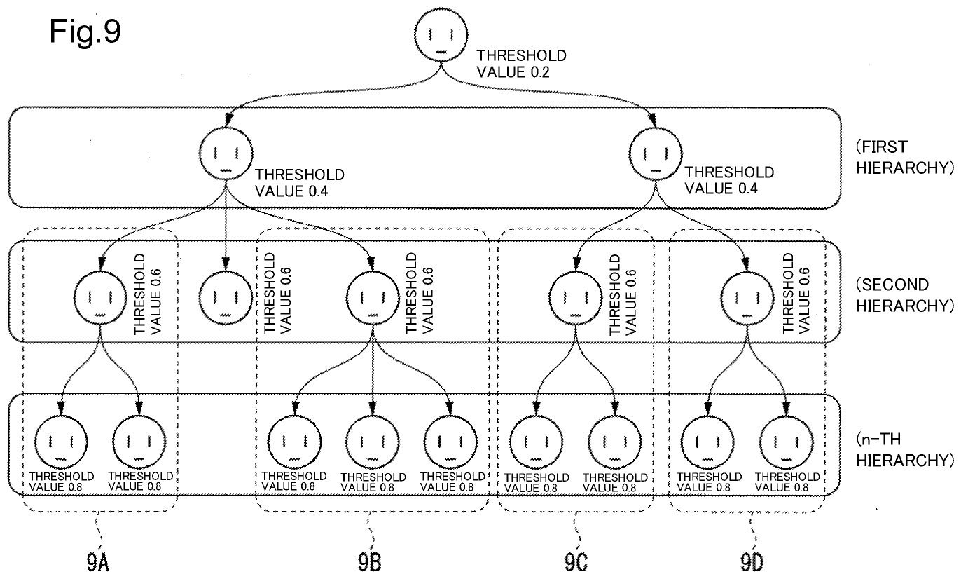

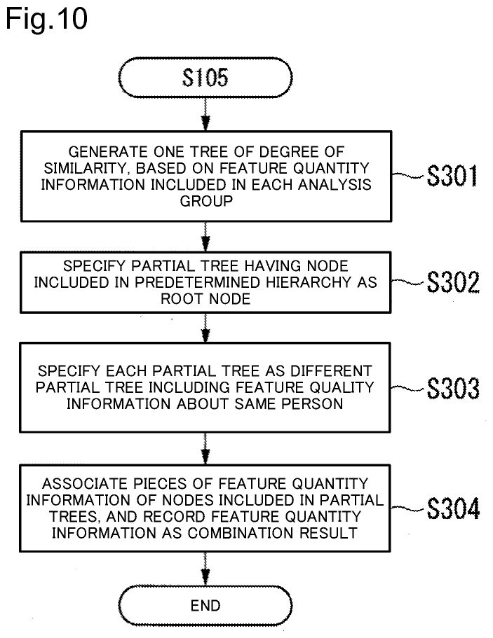

FIG. 7 is a second diagram illustrating an outline of match determination processing. FIG. 8 is a second diagram illustrating a processing flow of the match determination processing. Next, second match determination processing will be described. The second match determination processing below may be performed other than the first match determination processing described above.

The processing in steps S101 to S105 is similar to the first match determination processing. Then, in the combination unit 113, the evaluation unit 131 generates a tree of a degree of similarity for each analysis group, based on each piece of feature quantity information included in the first analysis group to the third analysis group (step S201). The tree of the degree of similarity is tree structure data generated based on a degree of similarity between feature quantities. A known technique may be used as a technique for generating a tree of a degree of similarity. FIG. 7 illustrates, as one example, a first tree of a degree of similarity (A) generated based on feature quantity information included in the first analysis group and a second tree of a degree of similarity (B) generated based on feature quantity information included in the second analysis group.

The evaluation unit 131 selects feature quantity information (a1, a2, and a3) indicating a node in a first hierarchy indicating a lower hierarchy following a root node (highest node) of the tree of the degree of similarity (A) of the first analysis group, and feature quantity information (b1 and b2) indicating a node in the first hierarchy indicating a lower hierarchy following a root node of the tree of degree of similarity (B) of the second analysis group (step S202). The face similarity degree calculation unit 114 calculates a degree of similarity between selected feature quantities included in the selected pieces of feature quantity information between the first analysis group and the second analysis group in a round-robin manner, based on an instruction of the evaluation unit 131 (step S203). The evaluation unit 131 determines whether a degree of similarity equal to or more than a predetermined threshold value is acquired in the round-robin calculation of the degree of similarity between the groups of the feature quantity information (a1, a2, and a3) and the feature quantity information (b1 and b2) (step S204). When the degree of similarity equal to or more than the predetermined threshold value is acquired, the evaluation unit 131 specifies, in the first hierarchy, a node of the feature quantity information whose degree of similarity is calculated (step S205). The evaluation unit 131 determines whether a next lower hierarchy connected to the node specified in the first hierarchy is a predetermined hierarchy being preset (step S206). The predetermined hierarchy is specified by, for example, a value indicating which hierarchy from the node. When the next lower hierarchy is not the predetermined hierarchy, the evaluation unit 131 selects feature quantity information of a node in a next second hierarchy connected to the node specified in the first hierarchy (step S207). The evaluation unit 131 calculates a degree of similarity between selected feature quantities included in the selected pieces of feature quantity information between the first analysis group and the second analysis group in a round-robin manner (step S208). The evaluation unit 131 repeats the processing in steps S204 to S208 until the predetermined hierarchy is reached. When the next lower hierarchy is the predetermined hierarchy being preset in step S206, the evaluation unit 131 specifies, in a last hierarchy, a node of feature quantity information whose degree of similarity equal to or more than the predetermined threshold value is calculated (step S209). The evaluation unit 131 calculates a degree of similarity between a feature quantity in the first analysis group and a feature quantity in the second analysis group in a round-robin manner for the feature quantities included in the pieces of feature quantity information specified in the lowest hierarchy node or the node lower than the predetermined hierarchy (step S210). The evaluation unit 131 determines whether the degree of similarity equal to or more than the predetermined threshold value is acquired in the round-robin calculation of the degree of similarity (step S211).

When the determination unit 132 determines that the degree of similarity equal to or more than the predetermined threshold value is acquired in step S211, the determination unit 132 determines that the feature quantity information about the person being the analysis target included in the first analysis group and the feature quantity information about the person being the analysis target included in the second analysis group are feature quantity information about the same person (step S212). The determination unit 132 associates the feature quantity information included in the first analysis group and the feature quantity information included in the second analysis group with each other, and records the feature quantity information as a combination result in the combination result holding unit 14 (step S213).

The combination unit 113 may perform similar processing by using the first feature quantity among the pieces of feature quantity information included in the first analysis group and the third feature quantity among the pieces of feature quantity information included in the third analysis group. Furthermore, the combination unit 113 may perform similar processing by using the second feature quantity among the pieces of feature quantity information included in the second analysis group and the third feature quantity among the pieces of feature quantity information included in the third analysis group.

### (Third Match Determination Processing)

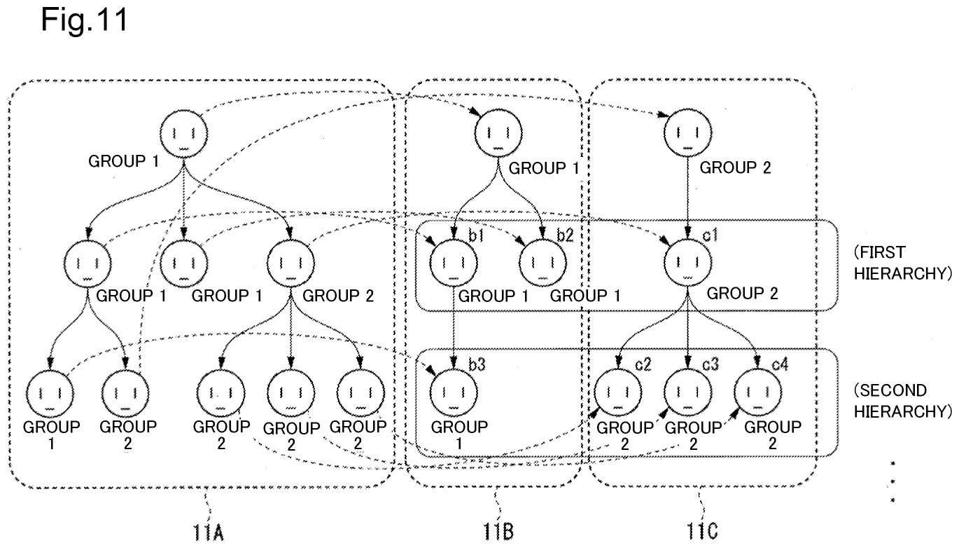

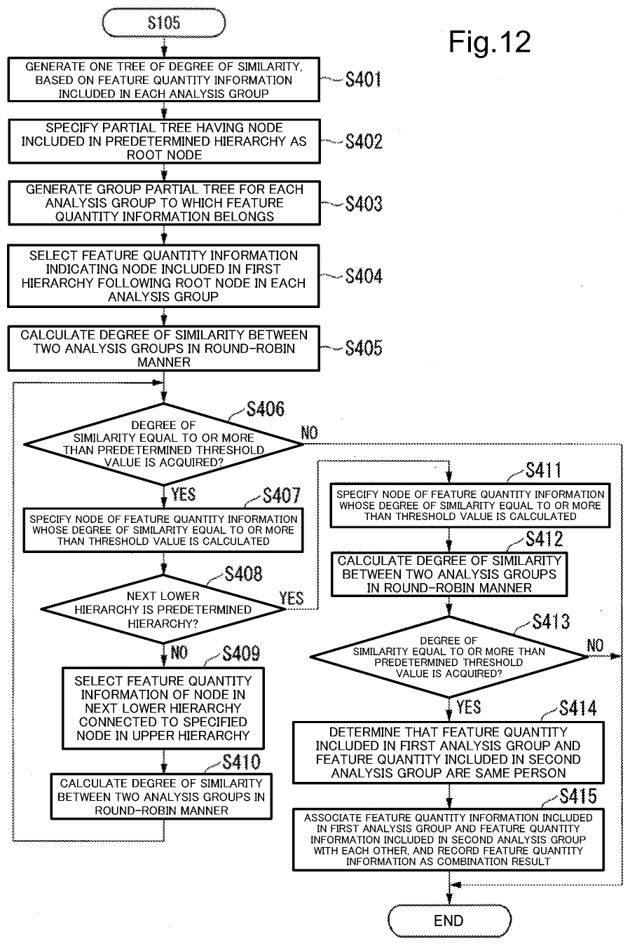

FIG. 9 is a third diagram illustrating an outline of match determination processing. FIG. 10 is a third diagram illustrating a processing flow of the match determination processing. Next, third match determination processing will be described. The third match determination processing below may be performed other than the first and second match determination processing described above.

The processing in steps S101 to S105 is similar to the processing in the first match determination processing. Then, in the combination unit 113, the evaluation unit 131 generates one tree of a degree of similarity, based on each piece of feature quantity information included in the first analysis group to the third analysis group (step S301). A known technique may be used as a technique for generating a tree of a degree of similarity. FIG. 9 illustrates a tree of a degree of similarity generated based on all pieces of feature quantity information included in the first analysis group, the second analysis group, and the third analysis group. In generation of the tree of the degree of similarity, the evaluation unit 131 generates the tree of the degree of similarity by using a threshold value of the degree of similarity between a feature quantity included in each piece of the feature quantity information in all the groups from the first analysis group to the third analysis group and a feature quantity included in another piece of feature quantity information. Specifically, in generation of the tree of the degree of similarity, the face similarity degree calculation unit 114 computes the degree of similarity between a feature quantity included in a certain piece of feature quantity information and a feature quantity included in any other piece of feature quantity information, based on an instruction of the evaluation unit 131. The evaluation unit 131 determines whether a feature quantity belongs to a node in a current target hierarchy. In determination whether a feature quantity belongs to a node in a certain target hierarchy, the evaluation unit 131 determines whether the calculated degree of similarity is equal to or more than a minimum degree of similarity and becomes less than a similarity degree threshold value (match evaluation threshold value) set in ascending order as a hierarchy of the tree of the degree of similarity becomes a lower hierarchy. When the degree of similarity calculated for the feature quantity of the certain piece of target feature quantity information is equal to or more than the minimum degree of similarity and less than the similarity degree threshold value, the evaluation unit 131 determines the node in the current target hierarchy. Then, the evaluation unit 131 determines that the feature quantity of the target feature quantity information is included in the node.

To provide description by using the example in FIG. 9, when a feature quantity of target feature quantity information indicates a feature quantity whose degree of similarity calculated between the feature quantity and another feature quantity is less than a minimum degree of similarity (for example, a threshold value 0.2 of a degree of similarity), the evaluation unit 131 specifies the target feature quantity information as a root node. The evaluation unit 131 excludes the target feature quantity information from a processing target.

Next, the evaluation unit 131 sets a target hierarchy node to one lower hierarchy (first hierarchy), and specifies, when a feature quantity of target feature quantity information remaining as a processing target indicates a feature quantity whose degree of similarity calculated between the feature quantity and another feature quantity is equal to or more than the minimum degree of similarity (for example, the threshold value 0.2 of the degree of similarity) and less than a threshold value 0.4, the target feature quantity information as a node in the first hierarchy.

Next, the evaluation unit 131 sets the target hierarchy node to one lower hierarchy (second hierarchy), and specifies, when a feature quantity of target feature quantity information remaining as a processing target indicates a feature quantity whose degree of similarity calculated between the feature quantity and another feature quantity is equal to or more than the minimum degree of similarity (for example, the threshold value 0.2 of the degree of similarity) and less than a threshold value 0.6, the target feature quantity information as a node in the second hierarchy.

Next, the evaluation unit 131 sets the target hierarchy node to one lower hierarchy (n-th hierarchy), and specifies, when a feature quantity of target feature quantity information remaining as a processing target indicates a feature quantity whose degree of similarity calculated between the feature quantity and another feature quantity is equal to or more than the minimum degree of similarity (for example, the threshold value 0.2 of the degree of similarity) and less than a threshold value 0.8, the target feature quantity information as a node in the n-th hierarchy.

Note that a degree of similarity between a feature quantity included in feature quantity information of a certain node in the same hierarchy and a feature quantity included in feature quantity information of another node is less than the minimum degree of similarity. The evaluation unit 131 generates a tree of a degree of similarity by such processing.

The evaluation unit 131 stores a predetermined hierarchy for specifying one person. The evaluation unit 131 specifies a partial tree (partial hierarchy structure) having a node included in the predetermined hierarchy as a root node (step S302). As one example, the specified partial trees are each a partial tree 9A, a partial tree 9B, a partial tree 9C, and a partial tree 9D having a node located in the second hierarchy (predetermined hierarchy) illustrated in FIG. 9 as a root node. In the processing, it is determined that features match for feature quantity information of each node included in one partial tree. The processing is one example of a processing aspect of evaluating whether analysis targets between a plurality of analysis groups match.

The determination unit 132 specifies that the partial tree 9A, the partial tree 9B, the partial tree 9C, and the partial tree 9D having the second hierarchy as a node are different partial trees each including feature quantity information about the same person (step S303). The determination unit 132 associates the pieces of feature quantity information of the nodes in the partial trees having the node included in the predetermined hierarchy as the root node, and records the feature quantity information as a combination result in the combination result holding unit 14 (step S304).

### (Fourth Match Determination Processing)

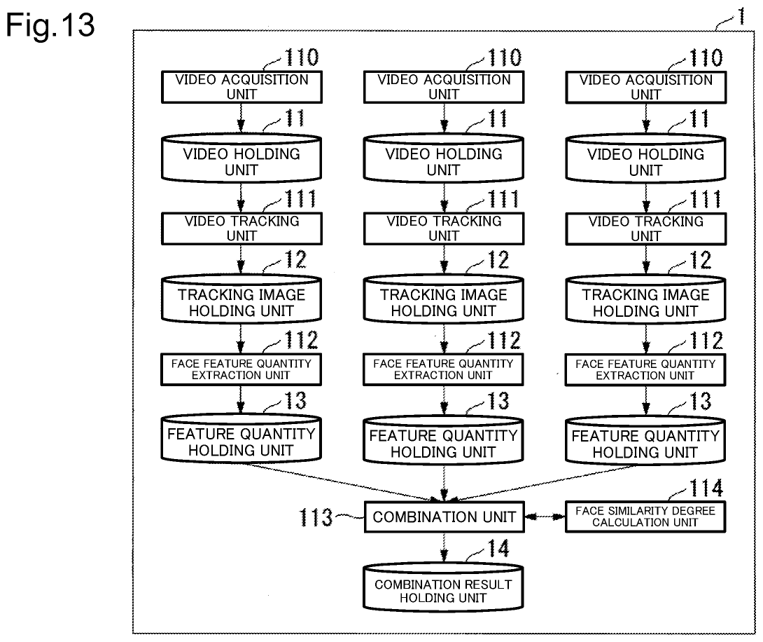

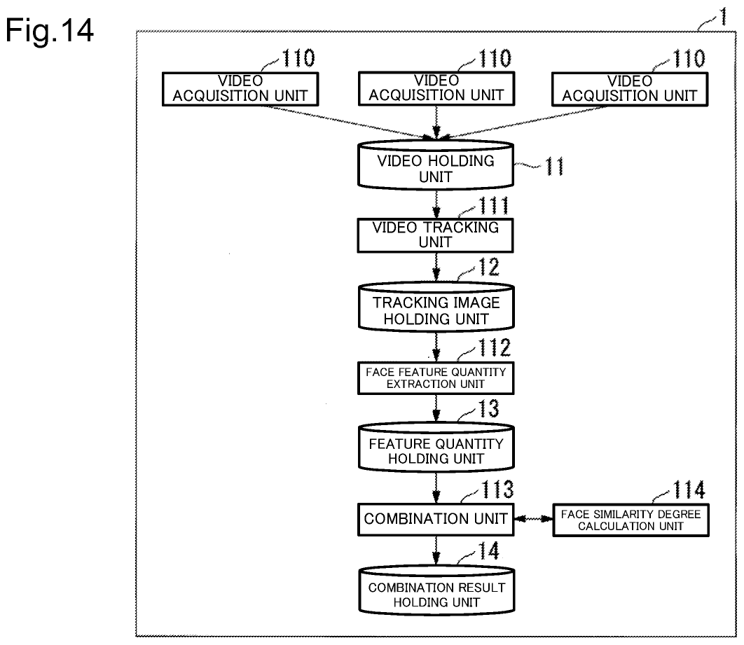

FIG. 11 is a fourth diagram illustrating an outline of match determination processing. FIG. 12 is a fourth diagram illustrating a processing flow of the match determination processing. Next, fourth match determination processing will be described. The fourth match determination processing below may be performed other than the first to third match determination processing described above. In the fourth match determination processing, the processing in steps S101 to S105 is similar to the first match determination processing. Further, in the fourth match determination processing, the evaluation unit 131 generates a tree of a degree of similarity similarly to the third match determination processing (step S401).

Then, the evaluation unit 131 specifies a partial tree having, as a root node, a node included in a predetermined hierarchy for specifying one person in the generated tree of the degree of similarity (step S402). In FIG. 11, a partial tree 11A indicates a partial tree having, as a root node, a node included in the predetermined hierarchy of one tree of the degree of similarity generated in step S401. The evaluation unit 131 generates a group partial tree for each analysis group to which feature quantity information belongs (step S403). Specifically, as illustrated in FIG. 11, when the partial tree 11A is formed with the node (highest node in the partial tree 11A in FIG. 11) included in the predetermined hierarchy as a root node, the evaluation unit 131 generates group partial trees 11B and 11C for each of analysis groups 1 and 2 to which feature quantity information included in each node of the partial tree 11A belongs. In the example in FIG. 11, it is assumed that, in the partial tree 11A, feature quantity information included in the group 1 being the first analysis group and feature quantity information included in the group 2 being the second analysis group are mixed in a node in the partial tree 11A. The evaluation unit 131 generates the first group partial tree 11B constituted of only the feature quantity information belonging to the group 1 being the first analysis group among the pieces of feature quantity information included in the node of the partial tree 11A and the second group partial tree 11C constituted of only the feature quantity information belonging to the group 2 being the second analysis group. In generation of the first group partial tree 11B and the second group partial tree 11C, as one example, the evaluation unit 131 generates group partial trees each constituted of only feature quantity information belonging to each group without disturbing a hierarchy relationship between nodes in the partial tree 11A as much as possible.

Further, in generation of a group partial tree, the evaluation unit 131 instructs calculation of a degree of similarity in such a way that a degree of similarity to a feature quantity included in feature quantity information in another of the same group is calculated with respect to feature quantity information of a node in the same group that is not in a hierarchy relationship between nodes in the partial tree 11A. Similarly to the third match determination processing, the evaluation unit 131 determines whether the calculated degree of similarity is equal to or more than a minimum degree of similarity and becomes less than a similarity degree threshold value set in ascending order as a hierarchy of the tree of a degree of similarity becomes a lower hierarchy, generates the tree of the degree of similarity, and forms a tree structure.

Next, the evaluation unit 131 performs an evaluation based on a degree of similarity by using the plurality of generated first group partial tree 11B and second group partial tree 11C, similarly to the second match determination processing. Specifically, the evaluation unit 131 selects feature quantity information (b1 and b2) indicating a node in a first hierarchy indicating a lower hierarchy following a root node of the first group partial tree 11B, and feature quantity information (c1) indicating a node in the first hierarchy indicating a lower hierarchy following a root node of the second group partial tree 11C (step S404). The face similarity degree calculation unit 114 calculates a degree of similarity between selected feature quantities included in the selected pieces of feature quantity information between the first group partial tree 11B and the second group partial tree 11C, based on an instruction of the evaluation unit 131 (step S405). The evaluation unit 131 determines whether a degree of similarity equal to or more than a predetermined threshold value is acquired in the round-robin calculation of the degree of similarity between groups of the feature quantity information (b1 and b2) and the feature quantity information (c1) (step S406). When the degree of similarity equal to or more than the predetermined threshold value is acquired, the evaluation unit 131 specifies, in the first hierarchy, a node of the feature quantity information whose degree of similarity is calculated (step S407).

The evaluation unit 131 determines whether a next lower hierarchy connected to the node specified in the first hierarchy is a predetermined hierarchy being preset (step S408). The predetermined hierarchy is specified by, for example, a value indicating which hierarchy from the node. When the next lower hierarchy is not the predetermined hierarchy, the evaluation unit 131 selects feature quantity information of a node in a next hierarchy (second hierarchy) connected to the node specified in the upper hierarchy (first hierarchy) (step S409). The evaluation unit 131 performs calculation of a degree of similarity between selected feature quantities included in the selected pieces of feature quantity information between the first analysis group and the second analysis group in a round-robin manner (step S410). The evaluation unit 131 repeats the processing in steps S406 to S410 until the predetermined hierarchy is reached. When the next lower hierarchy is the predetermined hierarchy being preset in step S408, the evaluation unit 131 specifies, in the predetermined hierarchy, a node of feature quantity information whose degree of similarity equal to or more than the predetermined threshold value is calculated (step S411). The evaluation unit 131 calculates a degree of similarity between a feature quantity in the first analysis group and a feature quantity in the second analysis group in a round-robin manner among the feature quantities included in the pieces of feature quantity information specified in the lowest hierarchy node or the node lower than the predetermined hierarchy (step S412). The evaluation unit 131 determines whether the degree of similarity equal to or more than the predetermined threshold value is acquired in the round-robin calculation of the degree of similarity (step S413).

When the determination unit 132 determines that the degree of similarity equal to or more than the predetermined threshold value is acquired in step S413, the determination unit 132 determines that the feature quantity information about the person being the analysis target included in the first analysis group and the feature quantity information about the person being the analysis target included in the second analysis group are feature quantity information about the same person (step S414). The determination unit 132 associates the feature quantity information included in the first analysis group and the feature quantity information included in the second analysis group with each other, and records the feature quantity information as a combination result in the combination result holding unit 14 (step S415). The match determination device 1 performs such processing on each combination of group partial trees.

### (With Regard to Other Configuration of Match Determination Device)

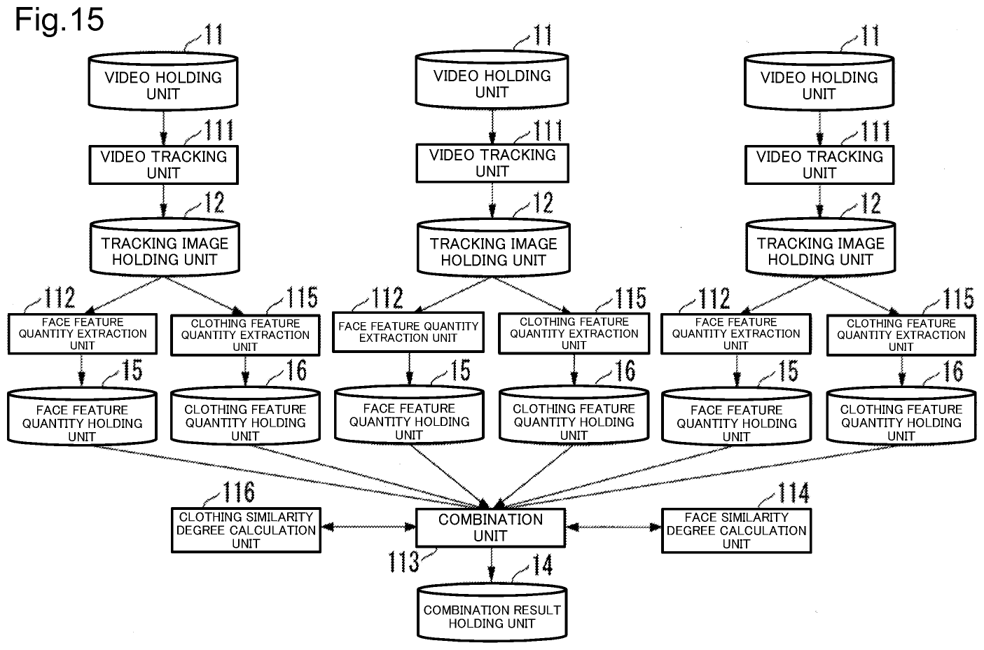

FIG. 13 is a second diagram illustrating a functional block of the match determination device.

As illustrated in FIG. 13, the match determination device 1 may include a video acquisition unit 110 in addition to the functional unit of the match determination device 1 illustrated in FIG. 3. Each of the video acquisition units 110 acquires video data transmitted from each of the cameras 2 associated with each of the video acquisition units 110.

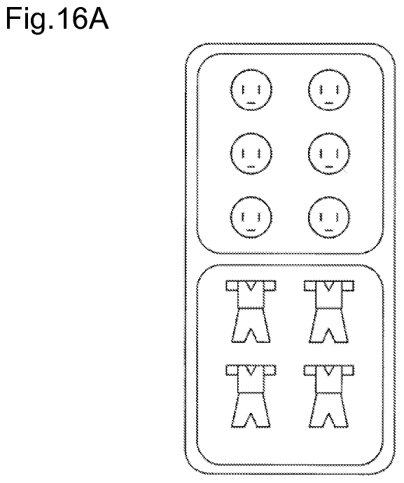

FIG. 14 is a third diagram illustrating a functional block of the match determination device. As illustrated in FIG. 14, the match determination device 1 includes the plurality of video acquisition units 110. Each of the plurality of video acquisition units 110 acquires video data transmitted from each of the cameras 2. Then, the match determination device 1 may process the video data acquired from each of the cameras 2 in the video tracking unit 111 and the face feature quantity extraction unit 112. In this case, one video holding unit 11, one tracking image holding unit 12, and one feature quantity holding unit 13 are also provided in the match determination device 1 in such a way as to be able to share and process each piece of the video data.

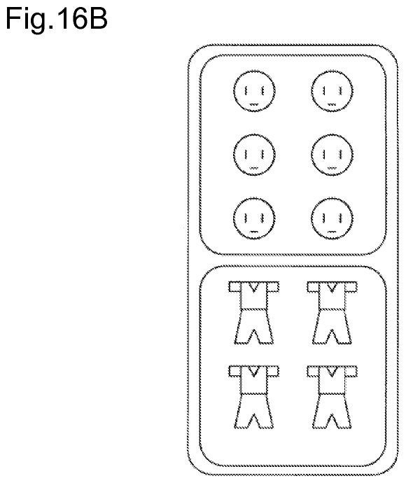

FIG. 15 is a fourth diagram illustrating a functional block of the match determination device. As illustrated in FIG. 15, the match determination device 1 may include a clothing feature quantity extraction unit 115, a clothing similarity degree calculation unit 116, a face feature quantity holding unit 15, and a clothing feature quantity holding unit 16 in addition to the functional unit of the match determination device 1 illustrated in FIG. 3.

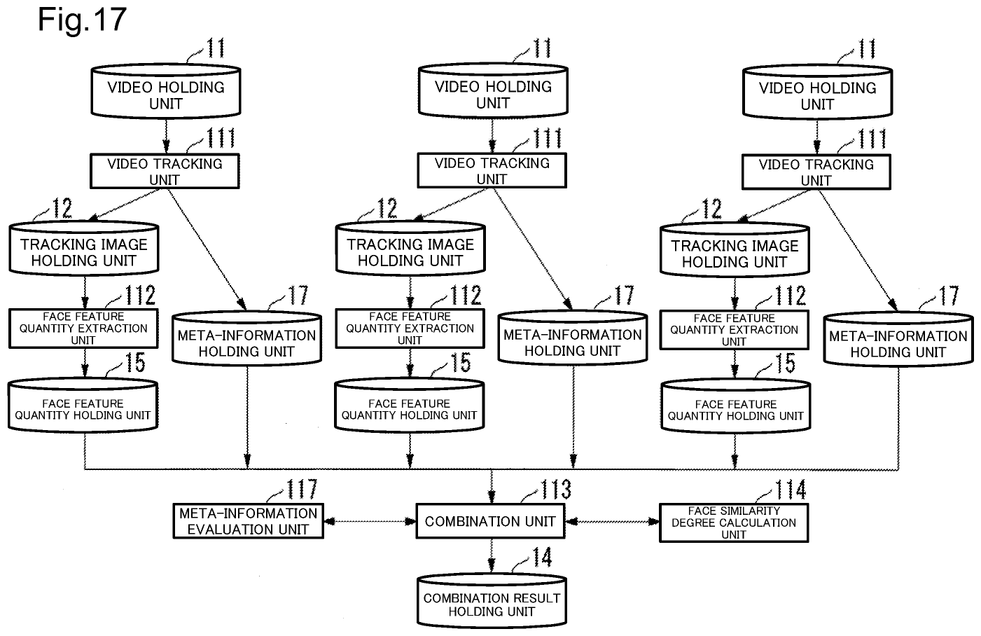

FIGS. 16A and 16B are a first diagram illustrating an outline of a feature quantity used for calculating a degree of similarity by the match determination device 1. FIG. 16A illustrates a combination of a face feature quantity and a clothing feature quantity extracted for a person as an analysis target from a frame image associated with first video data. FIG. 16B illustrates a combination of a face feature quantity and a clothing feature quantity extracted for a person as an analysis target from a frame image associated with second video data.

In the match determination device 1, the face feature quantity extraction unit 112 extracts a feature quantity of a face from a frame image recorded in the tracking image holding unit 12. The clothing feature quantity extraction unit 115 extracts a feature quantity of clothing. The face feature quantity extraction unit 112 records feature quantity information including the face feature quantity in the face feature quantity holding unit 15. The clothing feature quantity extraction unit 115 records feature quantity information including the clothing feature quantity in the clothing feature quantity holding unit 16. In calculation of a degree of similarity in the first match determination processing to the fourth match determination processing described above, the combination unit 113 instructs the face similarity degree calculation unit 114 to calculate a degree of similarity, based on the face feature quantity. Further, the combination unit 113 instructs the clothing similarity degree calculation unit 116 to calculate a degree of similarity, based on the clothing feature quantity. The combination unit 113 acquires the degree of similarity (degree of face similarity) based on the face feature quantity from the face similarity degree calculation unit 114. The combination unit 113 acquires the degree of similarity (degree of clothing similarity) based on the clothing feature quantity from the clothing similarity degree calculation unit 116. Then, the combination unit 113 may perform the first match determination processing to the fourth match determination processing by using a statistic (average value) based on the degree of face similarity and the degree of clothing similarity. Further, the combination unit 113 may perform the first match determination processing to the fourth match determination processing by using a degree of similarity having a greater degree of similarity among the degree of face similarity and the degree of clothing similarity. Alternatively, the combination unit 113 may perform the first match determination processing to the fourth match determination processing by using a degree of similarity having a smaller degree of similarity among the degree of face similarity and the degree of clothing similarity.

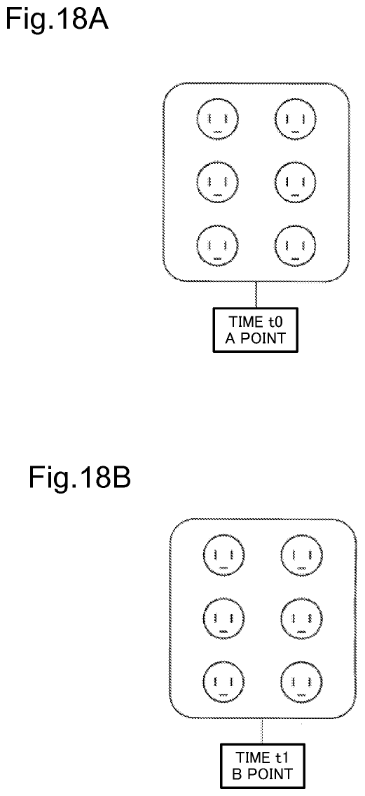

FIG. 17 is a fifth diagram illustrating a functional block of the match determination device. As illustrated in FIG. 17, the match determination device 1 may include a meta-information evaluation unit 117 and a meta-information holding unit 17 in addition to the functional unit of the match determination device 1 illustrated in FIG. 3.

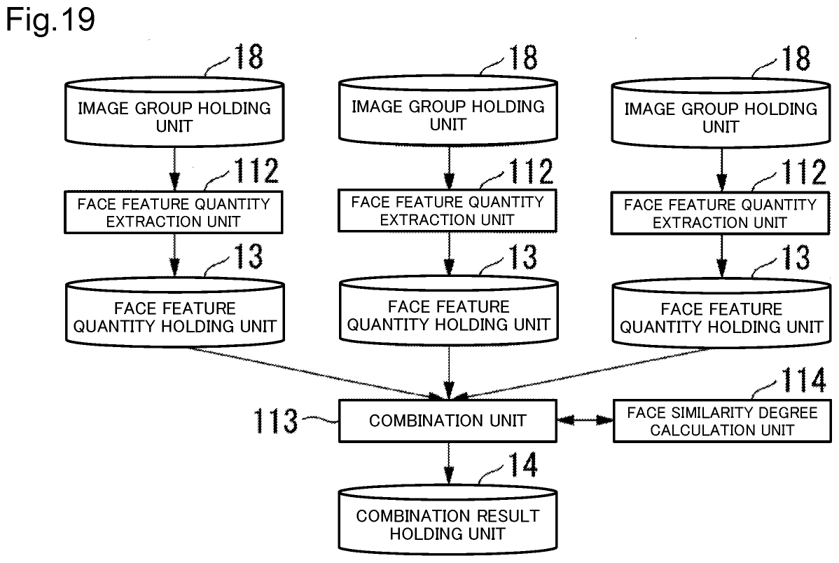

FIGS. 18A and 18B are a first diagram illustrating an outline of feature quantity information and meta-information used for calculating a degree of similarity by the match determination device. FIG. 18A illustrates a combination of a face feature quantity and meta-information extracted for a person as an analysis target from a frame image associated with the first video data. FIG. 18B illustrates a combination of a face feature quantity and meta-information extracted for a person as an analysis target from a frame image associated with the second video data.

As illustrated in FIGS. 18A and 18B, in such a way as to associate feature quantity information including the face feature quantity with the meta-information (attribute information such as a time, a point at which video data are captured, and coordinates), the match determination device 1 records the feature quantity information in the face feature quantity holding unit 15, and records the meta-information in the meta-information holding unit 17. In calculation of a degree of similarity in the first match determination processing to the fourth match determination processing described above, the combination unit 113 inquires of the meta-information evaluation unit 117 about whether the pieces of meta-information of the two feature quantities as calculation targets of a degree of similarity correspond to each other. The meta-information evaluation unit 117 acquires the pieces of meta-information related to the feature quantities from the meta-information holding unit 17. Further, when it is not determined that the pieces of meta-information are clearly not acquired from the same person, such as a case where a degree of matching of the pieces of meta-information is less than a predetermined threshold value, the meta-information evaluation unit 117 outputs, to the combination unit 113, that the calculation of a degree of similarity may be performed. Only when the combination unit 113 acquires, from the meta-information evaluation unit 117, the information indicating that the calculation of a degree of similarity may be performed, the combination unit 113 instructs the face similarity degree calculation unit 114 to calculate a degree of similarity.

According to such processing, when it is clear from meta-information that it is not the same person, an evaluation of matching of analysis targets can be accurately performed without calculating a degree of similarity between feature quantities.

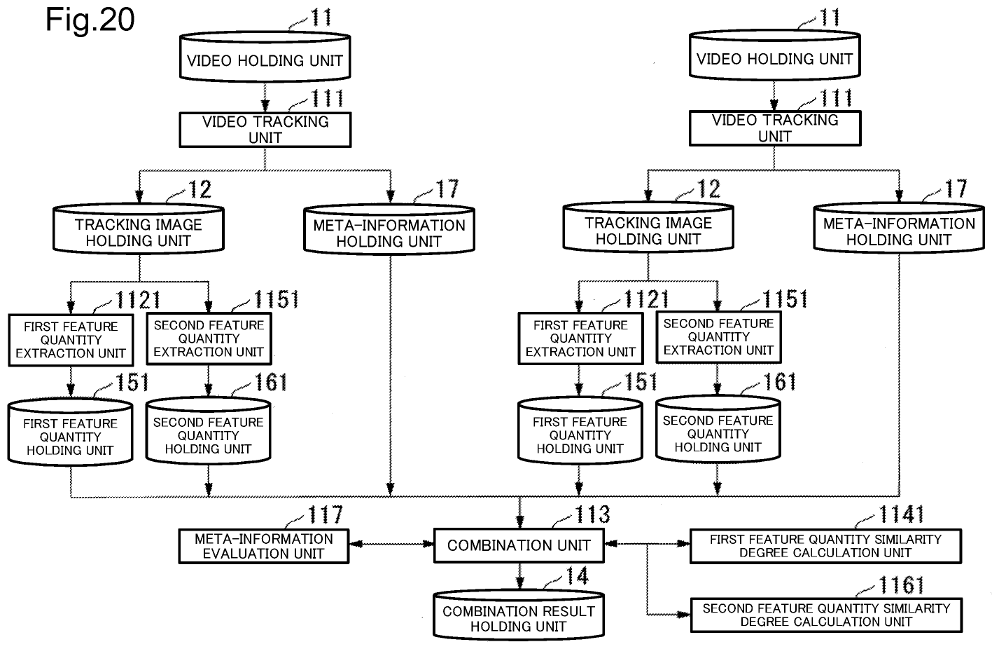

FIG. 19 is a sixth diagram illustrating a functional block of the match determination device. As illustrated in FIG. 19, the match determination device 1 may have the configuration of the functional unit and the holding unit of the match determination device 1 illustrated in FIG. 3 in which the configuration of the video holding unit 11 and the video tracking unit 111 is eliminated and an image group holding unit 18 is further included.

Each of the image group holding units 18 stores, for each of the cameras 2 associated with each of the image group holding units 18, a frame image as a result of being already subjected to the processing in step S101 to step S103 described above. For example, a manager causes another device to perform the processing in step S101 to step S103, and records a frame image group for each of the cameras 2 being acquired as a result of the processing in the image group holding unit 18 associated with each of the cameras 2. Then, the match determination device 1 performs the processing in and after step S104 similarly to the processing described above.

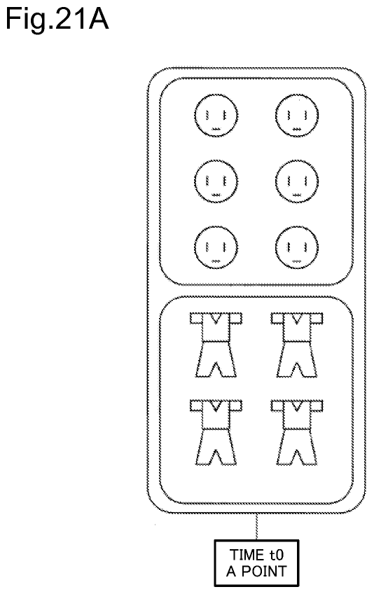

FIG. 20 is a seventh diagram illustrating a functional block of the match determination device. FIG. 20 illustrates a configuration in which a predetermined configuration of the functional unit of the match determination device 1 illustrated in FIG. 15 is replaced. Specifically, the face feature quantity extraction unit 112 is replaced with a first feature quantity extraction unit 1121. Further, the clothing feature quantity extraction unit 115 is replaced with a second feature quantity extraction unit 1151. The face feature quantity holding unit 15 is replaced with a first feature quantity holding unit 151. The clothing feature quantity holding unit 16 is replaced with a second feature quantity holding unit 161. The face similarity degree calculation unit 114 is replaced with a first feature quantity similarity degree calculation unit 1141. The clothing similarity degree calculation unit 116 is replaced with a second feature quantity similarity degree calculation unit 1161. Furthermore, the match determination device 1 is configured by adding the meta-information holding unit 17 and the meta-information evaluation unit 117 described by using FIG. 17.

In the description using FIGS. 1 to 19, the processing is performed by using feature quantity information indicating a feature quantity of a person included in video data. On the other hand, the processing may be similarly performed by using a plurality of feature quantities and pieces of meta-information of another analysis target. For example, the similar processing may also be performed by using a feature quantity (color as a first feature quantity and shape as a second feature quantity) of a moving body such as a vehicle included in video data and a feature quantity (color as a first feature quantity and shape as a second feature quantity) of a moving object such as baggage and the like.

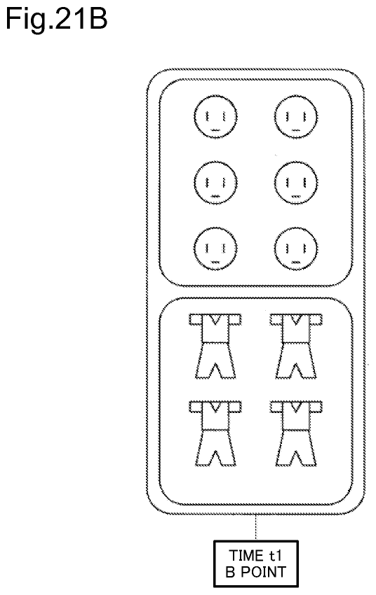

FIGS. 21A and 21B are a second diagram illustrating an outline of feature quantity information and meta-information used for calculating a degree of similarity by the match determination device. FIG. 21A illustrates a combination of the face feature quantity, the clothing feature quantity, and the meta-information extracted for a person as an analysis target from a frame image associated with the first video data. FIG. 21B illustrates a combination of the face feature quantity, the clothing feature quantity, and the meta-information extracted for a person as an analysis target from a frame image associated with the second video data.

The match determination device 1 records first feature quantity information including a face feature quantity being a first feature quantity in the first feature quantity holding unit 151, second feature quantity information including a clothing feature quantity being a second feature quantity in the second feature quantity holding unit 161, and meta-information (attribute information such as a time, a point at which video data are captured, and coordinates) in the meta-information holding unit 17 in such a way as to associate the first feature quantity information, the second feature quantity information, and the meta-information with one another. Note that a feature quantity may be a vibration quantity, sound, temperature, and the like of an analysis target.

In calculation of a degree of similarity in the first match determination processing to the fourth match determination processing described above, the combination unit 113 inquires of the meta-information evaluation unit 117 about whether the pieces of meta-information about the two feature quantities as calculation targets of a degree of similarity correspond to each other. The meta-information evaluation unit 117 acquires the pieces of meta-information related to the feature quantities from the meta-information holding unit 17. Then, when it is not determined that the pieces of meta-information are clearly not acquired from the same person, such as a case where a degree of matching of the pieces of meta-information is less than a predetermined threshold value, the meta-information evaluation unit 117 outputs, to the combination unit 113, that the calculation of a degree of similarity by each of the first feature quantity and the second feature quantity may be performed. Only when the combination unit 113 acquires, from the meta-information evaluation unit 117, the information indicating that the calculation of a degree of similarity may be performed, the combination unit 113 instructs the first feature quantity similarity degree calculation unit 1141 to calculate a degree of similarity by the first feature quantity and instructs the second feature quantity similarity degree calculation unit 1161 to calculate a degree of similarity by the second feature quantity.

According to such processing, when it is clear from meta-information that it is not the same person, based on a plurality of feature quantities and pieces of meta-information of analysis targets, an evaluation of matching of the analysis targets can be accurately performed without calculating a degree of similarity between feature quantities.

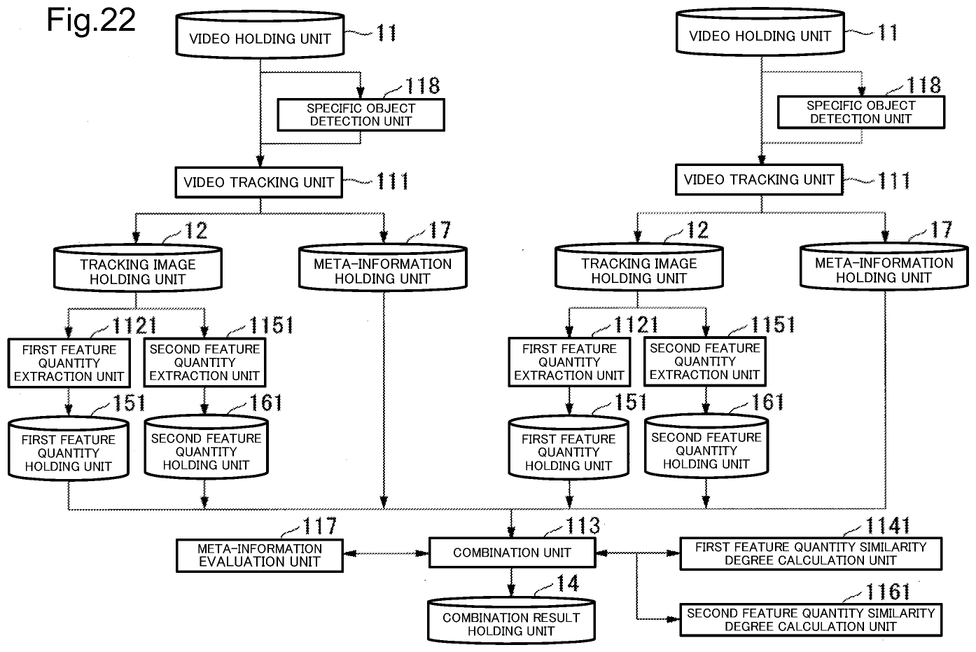

FIG. 22 is an eighth diagram illustrating a functional block of the match determination device. As illustrated in FIG. 22, the match determination device 1 may further include a function of a specific object detection unit 118 in addition to the configuration of the match determination device 1 illustrated in FIG. 20. The specific object detection unit 118 detects presence or absence of a desired object in video data recorded in the video holding unit 11. For example, the desired object may be a vehicle, baggage, and the like. A known technique may be used as a technique for detecting presence or absence of a desired object. The specific object detection unit 118 outputs an identifier of a frame image in which a desired object is captured in video data and the like to the video tracking unit 111. The video tracking unit 111 specifically specifies coordinates and a range of an object being an analysis target captured in the frame image, based on the identifier of the frame image of the desired object.

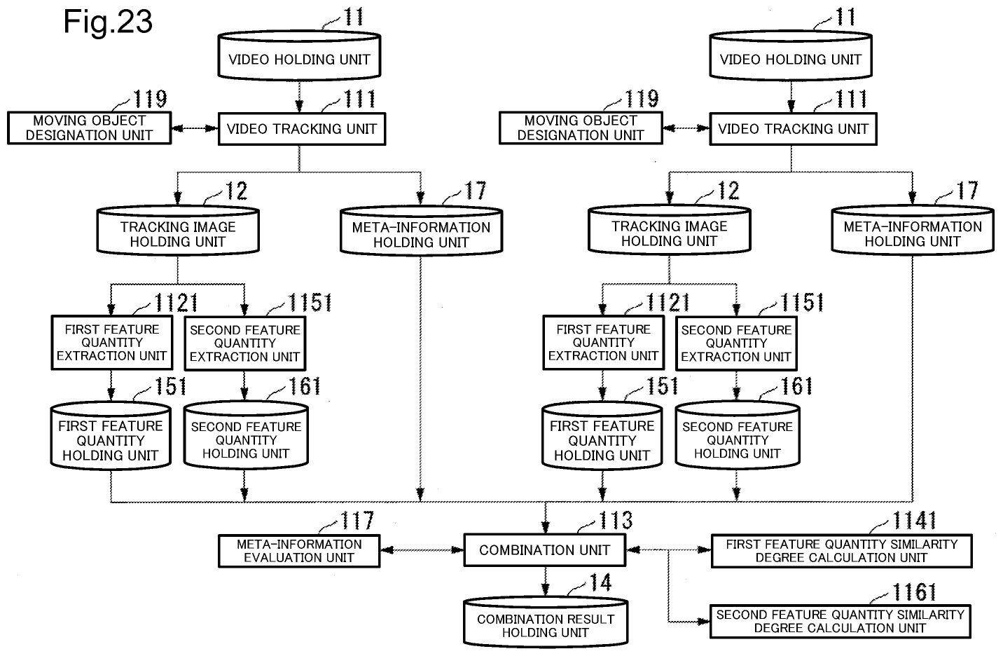

FIG. 23 is a ninth diagram illustrating a functional block of the match determination device. As illustrated in FIG. 23, the match determination device 1 may further include a function of a moving object designation unit 119 in addition to the configuration of the match determination device 1 illustrated in FIG. 20. The moving object designation unit 119 acquires designation of a position of a desired moving object in video by a user via a user interface. The moving object designation unit 119 outputs the position of the desired moving object in a frame image in video data to the video tracking unit 111. The video tracking unit 111 specifically specifies coordinates and a range of an object being an analysis target captured in the frame image, based on the position of the desired object in the frame image.

In each of the descriptions described above, the match determination device 1 evaluates matching of an analysis target between a plurality of pieces of video data, based on video data acquired from the camera 2. However, the match determination device 1 may evaluate matching of an analysis target between a plurality of pieces of sensing information, based on sensing information acquired from another sensing device except for the camera 2. The camera 2 is one aspect of a sensing device. Further, video data are one aspect of sensing information.

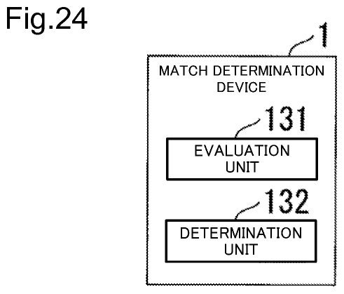

FIG. 24 is a diagram illustrating a minimum configuration of the match determination device. As illustrated in FIG. 24, the match determination device 1 may include at least the evaluation unit 131 and the determination unit 132. The evaluation unit 131 specifies a selected feature quantity being selected from one or a plurality of feature quantities for an analysis target included in an analysis group. Then, the evaluation unit 131 evaluates, based on a combination of selected feature quantities between different analysis groups, whether the analysis targets between the plurality of analysis groups match. When the evaluation indicates that the analysis targets between the analysis groups match, the determination unit 132 determines that the analysis targets in the different analysis groups are the same target.

The match determination device 1 described above includes a computer system therein. Then, a process of each processing described above is stored in a form of a program in a computer-readable recording medium, and the above-described processing is performed by reading and executing the program by a computer. Herein, the computer-readable recording medium refers to a magnetic disk, a magneto-optical disk, a CD-ROM, a DVD-ROM, a semiconductor memory, and the like. Further, the computer program may be distributed to the computer through a communication line, and the computer that receives the distribution may execute the program.

The above-mentioned program may achieve a part of the above-described function. Furthermore, the above-mentioned program may be achievable by a combination of the above-described function and a program that is already recorded in the computer system, namely, a difference file (difference program).

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2018-002207, filed on Jan. 10, 2018, the disclosure of which is incorporated herein in its entirety by reference.

### REFERENCE SIGNS LIST

100 Analysis system
1 Match determination device
2 Camera
11 Video holding unit
12 Tracking image holding unit
13 Feature quantity holding unit
14 Combination result holding unit
15 Face feature quantity holding unit
16 Clothing feature quantity holding unit
17 Meta-information holding unit
18 Image group holding unit
110 Video acquisition unit
111 Video tracking unit
112 Face feature quantity extraction unit
113 Combination unit
114 Face similarity degree calculation unit
115 Clothing feature quantity extraction unit
116 Clothing similarity degree calculation unit
117 Meta-information evaluation unit
118 Specific object detection unit
119 Moving object designation unit
1121 First feature quantity extraction unit
1151 Second feature quantity extraction unit
1141 First feature quantity similarity degree calculation unit
1161 Second feature quantity similarity degree calculation unit

What is claimed is:

1. A match determination device, comprising:
an evaluation unit specifying a selected feature quantity being selected from one or a plurality of feature quantities for an analysis target included in an analysis group, and evaluating, based on a combination of the selected feature quantities between different analysis groups, whether the analysis targets between a plurality of the analysis groups match; and
a determination unit specifying the analysis target in each of the different analysis groups as a same target when the evaluation indicates that the analysis targets between the analysis groups match.

2. The match determination device according to claim 1, wherein
the evaluation unit generates, for each of the analysis groups, a hierarchy structure based on a degree of similarity between a plurality of feature quantities for an analysis target included in the analysis group, evaluates matching between feature quantities each indicating a node in a first hierarchy indicating a hierarchy following each highest node in a hierarchy structure of the analysis group, performs, on a lower node in order, processing of evaluating matching between feature quantities in a hierarchy structure of the analysis group, in a next hierarchy connected to each of feature quantities in the first hierarchy that match in the evaluation, and specifies, in a predetermined hierarchy, the selected feature quantity indicating a feature quantity whose degree of similarity to another analysis group is equal to or more than a predetermined threshold value, and
the determination unit specifies, when each feature quantity indicating a node in the predetermined hierarchy in a hierarchy structure of the different analysis groups indicates matching between the analysis groups, the analysis target in each of the different analysis groups as a same target.

3. The match determination device according to claim 1, wherein
the evaluation unit generates, based on each piece of feature quantity information about an analysis target included in each of the analysis groups and a match evaluation threshold value being preset in ascending order in a lower hierarchy with respect to a highest node and each hierarchy node in a hierarchy structure, the hierarchy structure based on a degree of similarity, specifies a feature quantity of each node included in a partial hierarchy structure having, as a highest node, a hierarchy node indicating a predetermined match evaluation threshold value in the hierarchy structure as the selected feature quantity, and evaluates that the selected feature quantities match, and
the determination unit determines that the analysis target indicated by a feature quantity of each node included in a partial hierarchy structure having, as a highest node, a hierarchy node indicating the predetermined match evaluation threshold value in the hierarchy structure is a same target.

4. The match determination device according to claim 1, wherein
the evaluation unit generates, based on each piece of feature quantity information about an analysis target included in each of the analysis groups and a match evaluation threshold value being preset in ascending order in a lower hierarchy with respect to a highest node and each hierarchy node in a hierarchy structure, a hierarchy structure based on a degree of similarity, specifies feature quantity information in a same analysis group among pieces of feature quantity information of nodes included in a partial hierarchy structure having, as a highest node, a hierarchy node indicating a predetermined match evaluation threshold value in the hierarchy structure, and generates a group partial hierarchy structure by the feature quantity information in the same analysis group for each of the analysis groups,
the evaluation unit evaluates matching between the analysis groups of each feature quantity indicating a node in a first hierarchy indicating a hierarchy following a highest node in a group partial hierarchy structure for each of the analysis groups, performs, on a lower node in order, an evaluation of matching between the analysis groups by a feature quantity of each piece of feature quantity information in a next hierarchy connected to each piece of feature quantity information in the first hierarchy that matches in the evaluation, and specifies, in a predetermined hierarchy, the selected feature quantity indicating a feature quantity whose degree of similarity to another analysis group is equal to or more than a predetermined threshold value, and
the determination unit specifies, when each feature quantity indicating a node in the predetermined hierarchy in a group partial hierarchy structure of the different analysis group indicates matching between the analysis groups, the analysis target in each of the different analysis groups as a same target.

5. The match determination device according to claim 1, wherein
the evaluation unit determines, based on an attribute included in the feature quantity, a feature quantity of an analysis target included in the analysis group, and uses the feature quantity for evaluating whether the analysis targets match.

6. The match determination device according to claim 1, wherein
the evaluation unit evaluates whether the analysis targets match, based on a plurality of different feature quantities included in the feature quantity.

7. The match determination device according to claim 1, further comprising
a tracking unit specifying the analysis target, based on a moving body included in a moving image.

8. The match determination device according to claim 1, further comprising
a specific object detection unit specifying a specific object being the analysis target from a moving image.

9. A match determination method, comprising:
specifying a selected feature quantity being selected from one or a plurality of feature quantities for an analysis target included in an analysis group, and evaluating, based on a combination of the selected feature quantities between different analysis groups, whether the analysis targets between a plurality of the analysis groups match; and
specifying the analysis target in each of the different analysis groups as a same target when the evaluation indicates that the analysis targets between the analysis groups match.

10. A storage medium that stores a program causing a computer of a match determination device to function as:
an evaluation unit specifying a selected feature quantity being selected from one or a plurality of feature quantities for an analysis target included in an analysis group, and evaluating, based on a combination of the selected feature quantities between different analysis groups, whether the analysis targets between a plurality of the analysis groups match; and
a determination unit specifying the analysis target in each of the different analysis groups as a same target when the evaluation indicates that the analysis targets between the analysis groups match.
